(19) United States
(12) Patent Application Publication
(10) Pub. No.: US 2009/0190804 A1
(43) Pub. Date: Jul. 30, 2009

(54) ELECTRONIC APPARATUS AND IMAGE PROCESSING METHOD

(75) Inventor: Hidetoshi Yokoi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/356,377

(22) Filed: Jan. 20, 2009

(30) Foreign Application Priority Data
Jan. 29, 2008 (JP) 2008-018039

(51) Int. Cl. G06K 9/00; H04N 5/91; G06K 9/68

(52) U.S. Cl. 382/118; 386/46; 382/218; 386/E05.001

(57) ABSTRACT

According to one embodiment, a storage device stores a plurality of reference face images and a plurality of human names corresponding to the reference face images respectively. A face image extraction module extracts a plurality of face images from the moving image data to be processed. A matching processing module compares each of the extracted face images with the plurality of reference face images, and specifies a reference face image that appears within the moving image data to be processed. An association module associates human names corresponding to the specified reference face images, with the moving image data to be processed. A search module searches moving image data associated with the human names input by a user, from a plurality of moving image data to be searched.

### CROSS-REFERENCE TO RELATED APPLICATIONS

This application is based upon and claims the benefit of priority from Japanese Patent Application No. 2008-018039, filed Jan. 29, 2008, the entire contents of which are incorporated herein by reference.

### BACKGROUND

1. Field

One embodiment of the invention relates to an electronic apparatus and an image processing method for searching moving image data.

2. Description of the Related Art

Generally, an electronic apparatus such as a video recorder and a personal computer is capable of recording and playing back each kind of moving image data such as television broadcast program data. In this case, although a title name is added to each moving image data stored in the electronic apparatus, it is difficult to grasp what kind of content is included in each moving image data for a user. Therefore, in order to grasp the content of the moving image data, it is necessary to play back this moving image data. However, much time is required for playing back the moving image data having a long total time length, even if a fast forward playback function is used.

Accordingly, relatively much time is required for the user to find out user's desired moving image data, from a plurality of moving image data recorded in the electronic apparatus.

Also, recently, various image collating systems have been developed. According to an image collating system, generally similarity between two images is calculated.

Jpn. Pat. Appln. KOKAI Publication No. 2006-255027 discloses a monitoring system to which the image collating system is applied.

According to this monitoring system, a face image of an incomer photographed by a camera is collated with a preliminarily prepared face image of a fraudster. Then, when the face image of the incomer photographed by the camera coincides with the face image of the fraudster, the monitoring system notifies incoming of the fraudster.

However, according to the aforementioned Jpn. Pat. Appln. KOKAI Publication No. 2006-255027, no consideration is made regarding a search of the user's desired moving image data, from a plurality of moving image data. The electronic apparatus of recent years has large capacity storage, thus making it possible to store a lot of moving image data. In order to improve a using value of each moving image data of the plurality of stored moving image data, it is necessary to realize a mechanism of easily searching the user's desired moving image data, out of the plurality of moving image data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a system constitutional example of an electronic apparatus according to an embodiment of the invention;

FIG. 2 is an exemplary block diagram showing a function constitution of a program used by the electronic apparatus of the embodiment;

FIG. 3 is an exemplary diagram showing a constitutional example of a face database used by the electronic apparatus of the embodiment;

FIG. 4 is an exemplary diagram for explaining search index information prepared by the electronic apparatus of the embodiment;

FIG. 5 is an exemplary diagram showing an example of an operation from face database preparation processing to search processing of moving image data, executed by the electronic apparatus of the embodiment;

FIG. 6 is an exemplary flowchart showing an example of a procedure of video processing executed by the electronic apparatus of the embodiment;

FIG. 7 is an exemplary diagram showing an example of a search screen used by the electronic apparatus of the embodiment; and

FIG. 8 is an exemplary diagram showing an example of a search result screen used by the electronic apparatus of the embodiment.

### DETAILED DESCRIPTION

Various embodiments according to the invention will be described hereinafter with reference to the accompanying drawings. In general, according to one embodiment of the invention, there is provided an electronic apparatus including: a storage device configured to store a plurality of reference face images and a plurality of human names corresponding to the reference face images; a face image extraction module configured to extract a plurality of face images from moving image data to be processed; a matching processing module configured to execute matching processing of comparing each of the face images extracted from the moving image data to be processed with each of the reference face images, and specify a reference face image that appears within the moving image data to be processed; an association module configured to associate a human name corresponding to the specified reference face image, with the moving image data to be processed as search index information, based on a result of the matching processing; and a search module configured to search moving image data associated with the input human name, from a plurality of moving image data to be searched, based on the human name input by a user and the search index information of each of the plurality of moving image data to be searched.

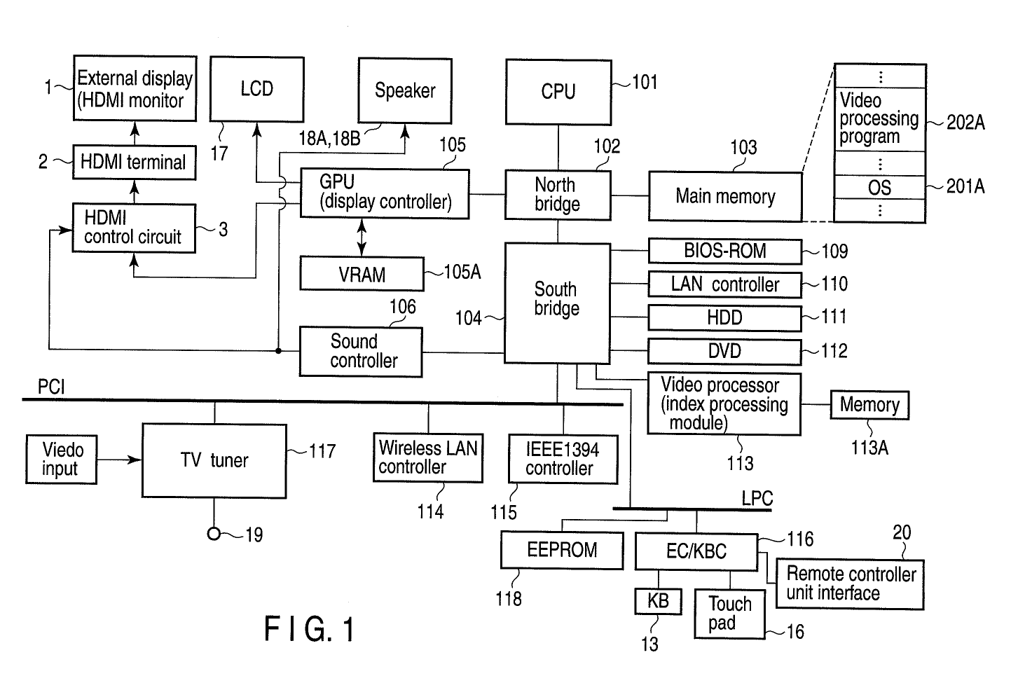

First, a system constitution of the electronic apparatus according to an embodiment of the present invention will be explained, with reference to FIG. 1. The electronic apparatus of this embodiment is an apparatus capable of recording and playing back moving image data, and this electronic apparatus is realized, for example, from a notebook type portable personal computer that functions as an information processing apparatus.

This computer can record and play back image video content data (audio visual content data) such as broadcast program data and video data input from external apparatus. Namely, this computer has a video processing function of treating the moving image data such as the broadcast program data broadcasted by a television broadcast signal and the video data input from external AV apparatus. This video processing function includes a function of executing viewing and video-recording the broadcast program data, and a function of recording and playing back the video data input from the external AV apparatus. For example, this video processing function is realized by a video processing program preliminarily installed in the computer.

Further, the video processing function also includes a moving image search function for easily searching user's desired moving image data, from a plurality of moving image data such as the video data and the broadcast program data stored in a storage device in a personal computer.

As shown in FIG. 1, this computer includes a CPU 101, a north bridge 102, a main memory 103, a south bridge 104, a graphics processing unit (GPU) 105, a video memory (VRAM) 105A, a sound controller 106, a BIOS-ROM109, a LAN controller 110, a hard disk drive (HDD) 111, a DVD drive 112, a video processor 113, a memory 113A, a wireless LAN controller 114, an IEEE 1394 controller 115, a embedded controller/keyboard controller IC (EC/KBC) 116, a TV tuner 117, and EEPROM 118, and so forth.

The CPU 101 serves as a processor for controlling an operation of this computer, and executes an operating system (OS) 201A and various application programs such as a video processing program 202A, which are loaded from the hard disk drive (HDD) 111 into the main memory 103. The video processing program 202A is the software for executing the video processing function. This video processing program 202A executes live playback processing for viewing the broadcast program data received by the TV tuner 117, video recording processing for recording the received broadcast program data in the HDD 111, and playback processing for playing back the broadcast program data/video data recorded in the HDD 111. In addition, the CPU 101 also executes BIOS (Basic Input Output System) stored in the BIOS-ROM 109. The BIOS is a program for controlling hardware.

The north bridge 102 serves as a bridge device making a connection between a local bus of the CPU 101 and the south bridge 104. A memory controller for performing access control of the main memory 103 is also incorporated in the north bridge 102. In addition, the north bridge 102 also has a function of executing communication with the GPU 105 via a serial bus, etc, based on PCI EXPRESS standard.

The GPU 105 serves as a display controller for controlling the LCD 17 used as a display device of this computer. A display signal generated by this GPU 105 is transmitted to the LCD 17. In addition, the GPU 105 can transmit a digital video signal to the external display device 1, via an HDMI control circuit 3 and an HDMI terminal 2.

The HDMI terminal 2 is an external display connection terminal for connecting the external display device. The HDMI terminal 2 can transmit uncompressed digital video signal and a digital audio signal to the external display device 1 such as a television, by one cable. The HDMI control circuit 3 is an interface for transmitting the digital video signal to the external display device 1 called an HDMI monitor, via the HDMI terminal 2.

The south bridge 104 controls each device on LPC (Low Pin Count) bus, and each device on PCI (Peripheral Component Interconnect) bus. In addition, the south bridge 104 incorporates an IDE (Integrated Drive Electronics) controller for controlling the hard disk drive (HDD) 111 and the DVD drive 112. Further, the south bridge 104 has the function of executing communication with the sound controller 106.

Still further, the video processor 113 is connected to the south bridge 104, via the serial bus based on PCI EXPRESS standard.

The video processor 113 serves as a processor for executing each kind of processing regarding the moving image data such as the broadcast program data and the video data. This video processor 113 functions as an index processing module for executing video index processing to the moving image data. Namely, in the video index processing, the video processor 113 extracts a plurality of face images from the moving image data to be processed. Extraction of the face image can be performed, for example for every scene of the moving image data. In this case, each face image that appears in this scene is extracted. For example, when face images of a plurality of persons appears in a certain scene, the face images of the plurality of persons are extracted.

The processing of extracting the face image is executed by face detection processing in which a human face area is detected from each frame of the moving image data, and cutting-out processing in which the detected face area is cut-out from the frame. The detection of the face area can be performed in such a manner that characteristics of the image of each frame are analyzed and the area having a similar characteristic is searched as a preliminarily prepared face image characteristic sample. The face image characteristic sample means characteristic data obtained by statistically processing face image characteristics of many persons.

The memory 113A is used as a working memory of the video processor 113. A large amount of calculations are necessary for executing the video index processing. In this embodiment, the video processor 113, being a dedicated processor different from the CPU 101, is used as a backend processor, and by this video processor 113, the video index processing is executed. Therefore, the video index processing can be executed, without inviting an increase of a load of the CPU 101.

Note that the extraction of the face image is not necessarily performed for every scene, and for example, it is also possible to divide the moving image data into a plurality of partial sections, and each human face image that appears in this partial section may be extracted, for every partial section.

The sound controller 106 serves as a sound source device, and audio data to be played back is output by this sound controller 106, to speakers 18A, 18B, or the HDMI control circuit 3.

The wireless LAN controller 114 serves as a wireless communication device for executing wireless communication based on IEEE 802.11 standard, for example. The IEEE 1394 controller 115 executes communication with the external apparatus via the serial bus based on IEEE 1394 standard.

The embedded controller/keyboard controller IC (EC/KBC) 116 is one chip micro computer in which the embedded controller for power management and the keyboard controller for controlling a keyboard (KB) 13 and a touch pad 16 are integrated. This embedded controller/keyboard controller IC (EC/KBC) 116 has the function of turning on/off power of this computer according to the operation of a power button 14 by a user. Further, the embedded controller/keyboard controller IC (EC/KBC) 116 has the function of executing communication with a remote control unit interface 20.

The TV tuner 117 serves as a receiving device for receiving the broadcast program data broadcasted by the television (TV) broadcast signal, and is connected to an antenna terminal 19 provided in this computer body. This TV tuner 117 is realized as a digital TV tuner capable of receiving digital broadcast program data such as digital terrestrial TV broadcast. In addition, the TV tuner 117 has the function of capturing the video data input from the external apparatus.

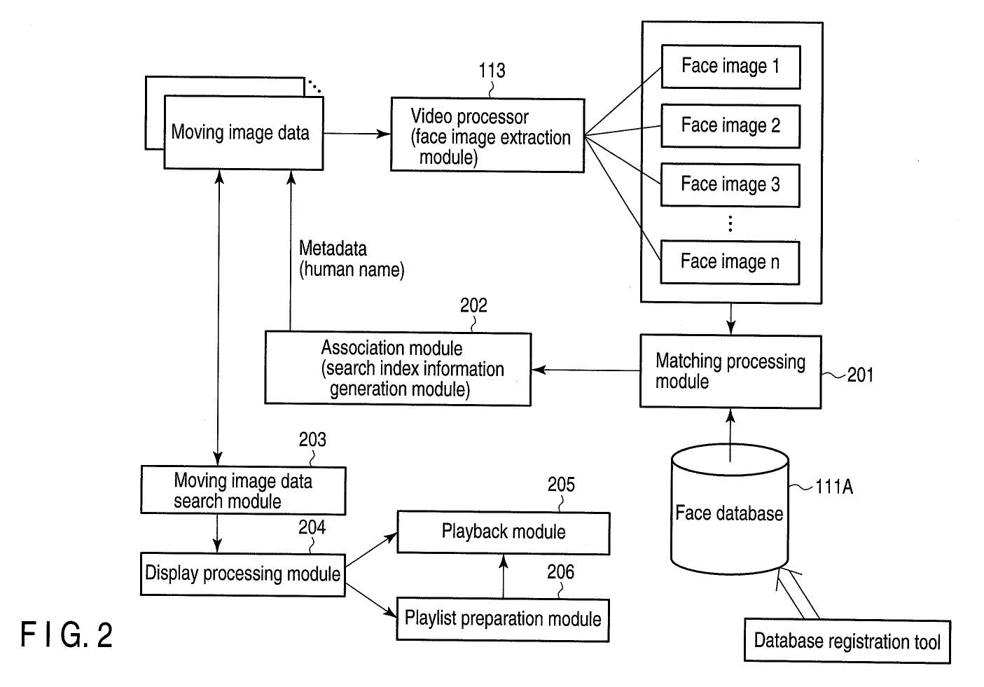

Next, referring to FIG. 2, the function constitution of the video processing program 202A will be explained.

The video processing program 202A includes a face database 111A, a matching processing module 201, an association module 202, a moving image data search module 203, a display processing module 204, a playback module 205, and a playlist preparation module 206, and so forth.

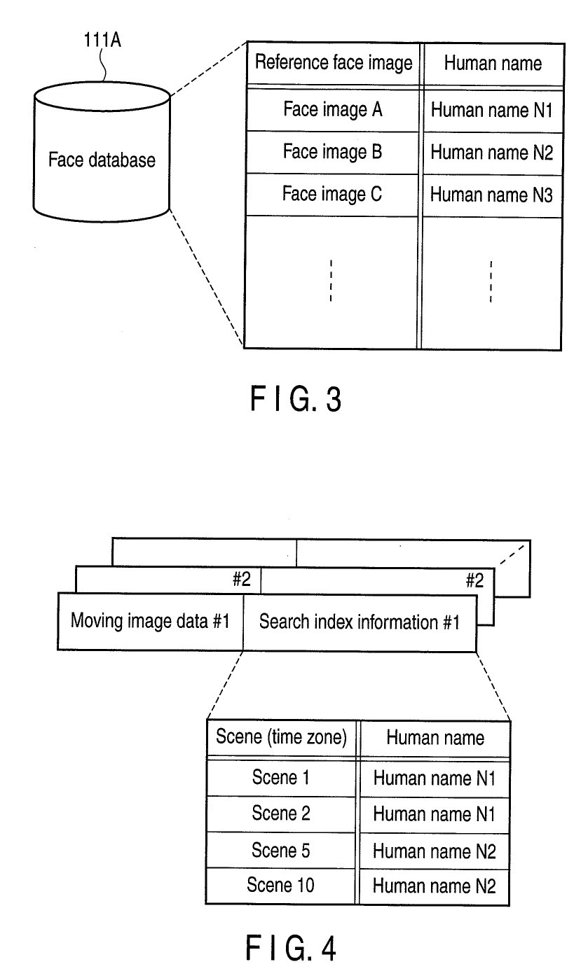

The face database 111A serves as a database for storing a pair of the face image (reference face image) and metadata such as a human name. As shown in FIG. 3, a plurality of reference face images and a plurality of human names corresponding to the plurality of reference face images are stored in this face database 111A. By using a database registration tool (DB registration tool) being the program related to the video processing program 202A, the user can store an arbitrary face image and the human name corresponding to this face image in the face database 111A. An arbitrary character string can be used as the human name, whereby the person corresponding to the face image can be identified (such as human name, and this person's nickname, etc.).

The user can register the face image and the human name in the face database 111A as the reference face image and search index information, by operating the database registration tool. As the face image, for example, it is possible to use the face image data obtained from a site on the Internet or the face image data obtained by photographing using a digital camera. In addition, the user also can register each face image in the face database 111A as the reference face image, the face image being extracted from a certain moving image data by the video processor 113.

Under the control of the video processing program 202A, the video processor 113 functions as a face image extraction module for extracting a plurality of face images from each moving image data to be processed, stored in a recording medium such as the HDD 111, etc. In this case, the video processor 113 extracts a plurality of face images from a plurality of scenes included in the moving image data to be processed.

The matching processing module 201 executes matching processing to compare each one of the plurality of face images (face images 1, 2, . . . , n) extracted from the moving image data to be processed by the video processor 113, with the plurality of reference face images within the face database 111A, and specifies the reference face images corresponding to persons that appear in the moving image data to be processed, out of the plurality of reference face images.

In the matching processing, the matching processing module 201 can specify, for every scene, the reference face image that appears in this scene, by comparing each one of the plurality of face images extracted from each one of the plurality of scenes of the moving image data to be processed with each one of the plurality of reference face images within the face database 111A. Each extracted face image and the reference face image can be compared, for example, by performing the processing of calculating similarity between the image characteristic of the extracted face image and the image characteristic of the reference face image, or by performing pattern matching between the extracted face image and the reference face image.

By the matching processing module 201, it is possible to specify which of the reference face images within the face database 111A appears in the moving image data to be processed.

The association module 202 executes the processing of generating the search index information corresponding to the moving image data to be processed, by using a result of the matching processing by the matching processing module 201. The search index information is the metadata used for searching the moving image data. Specifically, based on the result of the matching processing, the association module 202 associates the human name corresponding to the reference face image specified as described above with the moving image data to be processed, as the aforementioned search index information. For example, when it is so determined by the aforementioned matching processing that the face image similar to a face image A within the face database 111A of FIG. 3 is included in the moving image data to be processed, human name N1 corresponding to the face image A is associated with the moving image data to be processed.

Such an association processing can be performed for every scene within the moving image data to be processed. In this case, the association module 202 associates the human name corresponding to the reference face image that appears in the scene, with each scene within the moving image data to be processed, as the search index information. FIG. 4 shows an example of the search index information associated with the moving image data to be processed by the association module 202. In FIG. 4, search index information #1 is associated with moving image data #1. The search index information #1 is the information showing the human name corresponding to each face image that appears in the moving image data #1. For example, in a plurality of scenes constituting the moving image data #1, this search index information #1 shows, for every scene (for every time zone corresponding to this scene) in which any one of the reference face images in the face database 111A appears, the human name corresponding to the reference face image that appears in this scene. For example, when the face image similar to the face image A in the face database 111A of FIG. 3 appears in the scenes 1 and 2 of the moving image data #1, and the face image similar to the face image B in the face database 111A of FIG. 3 appears in the scenes 5 and 10 of the moving image data #1 respectively, then, as shown in FIG. 4, the search index information #1 includes the information showing that the persons having names N1, N1, N2, N2 appear in the scenes 1, 2, 5, 10 respectively. A data structure of the search index information #1 is not particularly limited, and any data structure can be taken, for example, only by including time information showing the time zone of each scene in which a certain reference face image appears, and by including the human name corresponding to the reference face image that appears in the aforementioned each scene.

The moving image data search module 203 searches from a plurality of moving image data to be searched, the moving image data associated with an input human name by typing, namely, the moving image data including the face image corresponding to the human name input by typing, based on the human name input by typing by the user as a keyword and the search index information of each moving image data to be searched. For example, each moving image data stored in a specific storage area (specific directory, etc.) within the HDD 111 can be an object to be searched.

As is explained in FIG. 4, when the search index information includes the human name that appears in the scene for every scene, the moving image data search module 203 can search the moving image data associated with the human name input by typing, from the moving image data group to be searched. In addition, the moving image data search module 203 can search each scene associated with the human name input by typing, from each moving image data to be searched.

Based on the result of the search by the moving image data search module 203, the display processing module 204 displays a search result screen on the display device. Specifically, the display processing module 204 executes the processing of displaying on a display screen (search result screen), a list of the moving image data searched by the moving image data search module 203, or executes the processing of displaying on a search result screen, a list of a searched scene (list of the scenes associated with human names input by typing), for every moving image data associated with the human names input by typing.

When one of the moving image data is selected to be played back by the user from the list of the moving image data on the search result screen, the playback module 205 executes the processing of playing back the selected moving image data. In addition, in a case where the list of the scenes searched from each moving image data is displayed on the search result screen, when one of the scenes is selected to be played back by the user from the list of the scenes, the playback module 205 starts the playback of the moving image data including a selected scene from this selected scene.

Further, the playback module 205 has the function of sequentially playing back each moving image data designated by a playlist (playlist information) selected by the user. The playlist is the information for defining each moving image data to be played back, and includes an identifier (each file name of the moving image data to be played back) for identifying each moving image data to be played back. When a predetermined playback request event is input by operation of the user in a state in which the playlist is selected by the user, the playback module 205 sequentially plays back each moving image data designated by the identifier included in the selected playlist.

The playlist preparation module 206 automatically generates the playlist including the identifier for identifying each searched moving image data, by using the search result obtained by the moving image data search module 203, and stores the generated playlist in the HDD 111. The processing of preparing the playlist is executed, for example, when a preparation request event of the playlist is input by operation of the user in a state in which the search result screen is displayed. By this playlist preparation function, the playlist regarding the human name input by typing by the user can be easily prepared. In addition, by using this playlist preparation function, the playlist for each person can be easily prepared.

As an example of a using form of a video processing function of this embodiment, for example, an explanation will be given for a case of treating a certain moving image data obtained by photographing by a movie camera, for example, such as a case of treating the moving image data of a sports festival photographed by parents, in which their own children appears.

When the user designates this moving image data as a processing object, the video processing program 202A executes picture analysis of the moving image data to be processed by using the video processor 113, and extracts a plurality of face images from the moving image data to be processed.

Then, the video processing program 202A executes matching processing of comparing each one of the extracted plurality of face images with each one of the plurality of reference face images stored in the face database 111A.

If the face image of the child is preliminarily registered in the face database 111A as one of the reference face images, by the aforementioned matching processing, the face image of the child is specified as the reference face image that appears in the moving image data to be processed. Then, the video processing program 202A associates the metadata showing the human name (name of the child) corresponding to the face image of the child stored in the face database 111A by using the association module 202, with the moving image data to be processed, as the search index information. Thus, only by inputting the name of the child as the keyword by the user thereafter, this moving image data can be easily searched. Therefore, according to this embodiment, the moving image data in which user's desired person appears can be easily searched from the plurality of moving image data stored in the HDD 111 of this computer.

In addition, according to this embodiment, the metadata showing the name of the child can be associated with each scene where the face image of the child appears, out of the scenes within the moving image data. Therefore, only by inputting the name of the child as the keyword, the user can search only the scene where the face image of the child appears, out of the scenes within the moving image data.

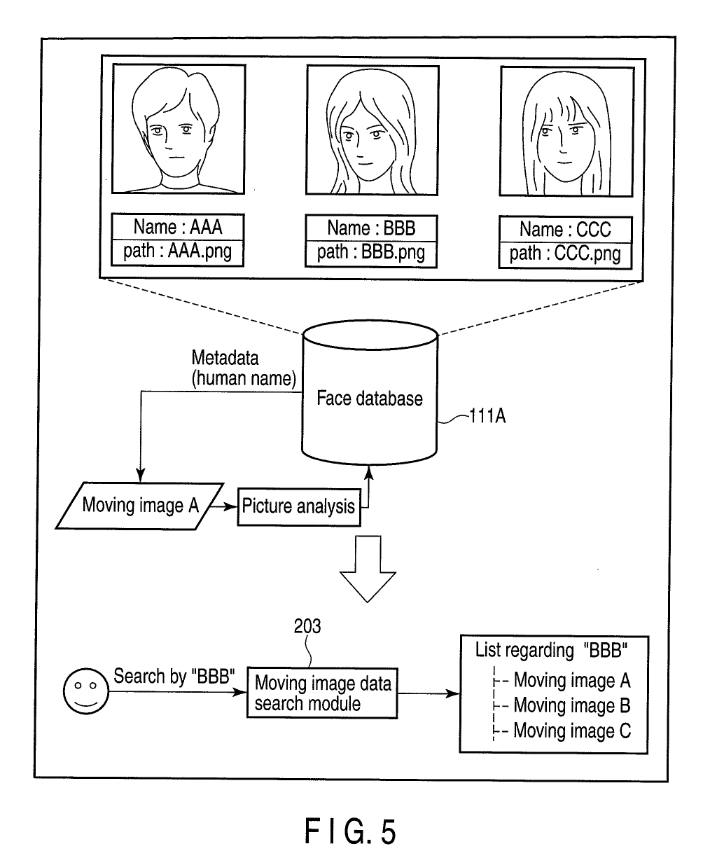

Next, the operation ranging from the preparation processing of the face database 111A to the search processing of the moving image data will be explained, with reference to FIG. 5.

By operating the aforementioned database registration tool, the user can store arbitrary face image data and the human name (name) corresponding to this face image data in the face database 111A. FIG. 5 shows a case in which the face images of three persons A, B, and C are respectively stored in the face database 111A as the reference face image.

Namely, the face database 111A includes first reference face image information including the face image “AAA.png” and its name “AAA” of the person A, second reference face image information including the face image “BBB.png” and its name “BBB” of the person B, and third reference face image information including the face image “CCC.png” and its name “CCC” of the person C.

When the user designates a certain moving image data A stored in the HDD 111 as the processing object, the video processing program 202A executes picture analysis of the moving image data A in each frame by using the video processor 113, and from the moving image data A, extracts each human face image that appears in the moving image data A.

Then, by using the matching processing module 201, the video processing program 202A executes matching processing of comparing each one of the plurality of extracted face images, with each one of the three reference face images stored in the face database 111A, and specifies the reference face image that appears within the moving image data A. If the face image similar to the reference face image “BBB.png” appears within the moving image data A, by the aforementioned matching processing, the reference face image “BBB.png” is specified as the reference face image that appears within the moving image data A. Then, the video processing program 202A associates the name “BBB” corresponding to the reference face image “BBB.png” with the moving image data A as the search index information, by using the association module 202. Thus, thereafter, only by inputting the name “BBB” by the user as the keyword for searching, this moving image data A can be easily searched.

Namely, in the image search processing, when the user inputs the name “BBB” by typing as the keyword for searching, the video processing program 202A searches the moving image data associated with the search index information including the name “BBB”, from all of the moving image data items to be searched, by using the moving image data search module 203. For example, in the moving image data items to be searched, if each of the moving image data A, B, C is associated with the search index information including the name “BBB”, the moving image data A, B, C are searched as the moving image list in which the person regarding the name “BBB” appears.

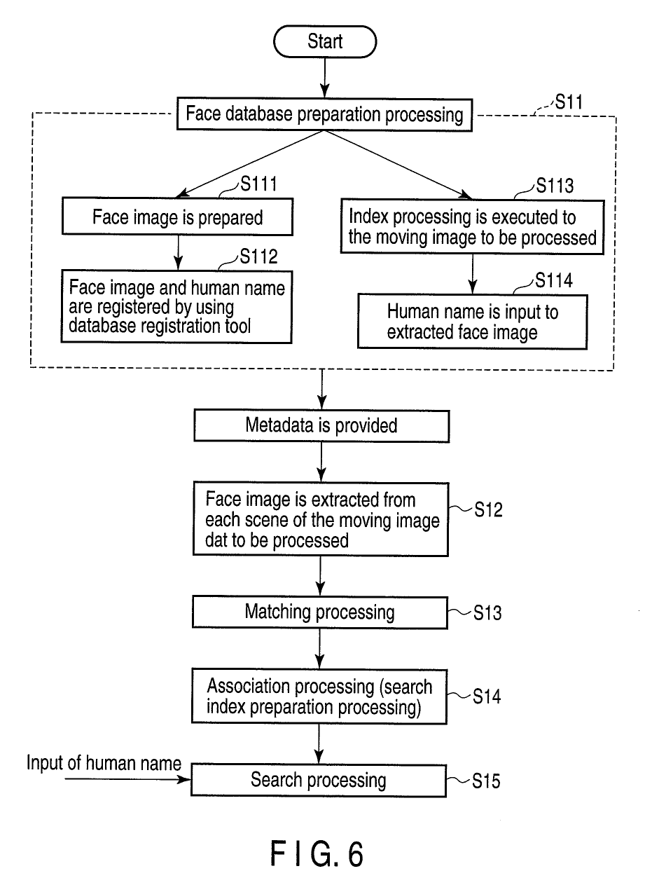

Next, an example of a procedure of video processing according to this embodiment will be explained, with reference to the flowchart of FIG. 6.

First, the video processing program 202A executes the processing of generating the face database 111A according to the operation of the user (block S11). In this case, first, the user prepares the face image to be registered in the face database 111A (block S111). Then, the database registration tool stores the face image designated by the user and the human name input by the user in the face database 111A (block S112).

In addition, it is also possible to generate the face database 111A, by using the face image obtained by the video index processing executed by the video processor 113. In this case, by using the video processor 113, the video processing program 202A executes the video index processing to the moving image designated by the user, and extracts a plurality of face images from the moving image (block S113). Thereafter, the video processing program 202A stores in the face database 111A, the face image selected by the user from the plurality of face images, and the human name input by the user (block S114).

Next, the video processing program 202A executes metadata providing processing for providing the metadata to the moving image data to be processed as the search index information. In this case, by using the video processor 113, the video processing program 202A executes the processing of extracting a plurality of face images from each one of the plurality of scenes included in the moving image data designated to be processed by the user (block S12).

In the block S12, the video processor 113, for example, detects a scene variation point of the moving image data to be processed, and specifies a section belonging to two adjacent scene variation points as the scene. Then, the video processor 113 extracts from each of the scenes, the human face image that appears in the scene. When a plurality of human face images appears in one scene, the face images corresponding to the plurality of persons may be extracted from this scene.

Thereafter, by using the matching processing module 201, the video processing program 202A executes matching processing of comparing each one of the plurality of human face images extracted from the moving image data to be processed, with each one of the reference face images stored in the face database 111A (block S13). In the block S13, each one of the plurality of face images extracted from each one of the plurality of scenes of the moving image data to be processed, is compared with each one of the reference face images stored in the face database 111A. Thus, one or more reference face images that appear in the scene are specified, for every scene of the moving image data to be processed.

Subsequently, by using the association module 202, the video processing program 202A generates the search index information corresponding to the moving image data to be processed (block S14). In this block S14, the video processing program 202A executes the processing of associating each scene of the moving image data to be processed, with the human name corresponding to the reference face image that appears in this scene as the index information. Specifically, the video processing program 202A generates the search index information as explained in FIG. 4, and associates this generated search index information with the moving image data to be processed.

Next, search processing executed by the video processing program 202A will be explained.

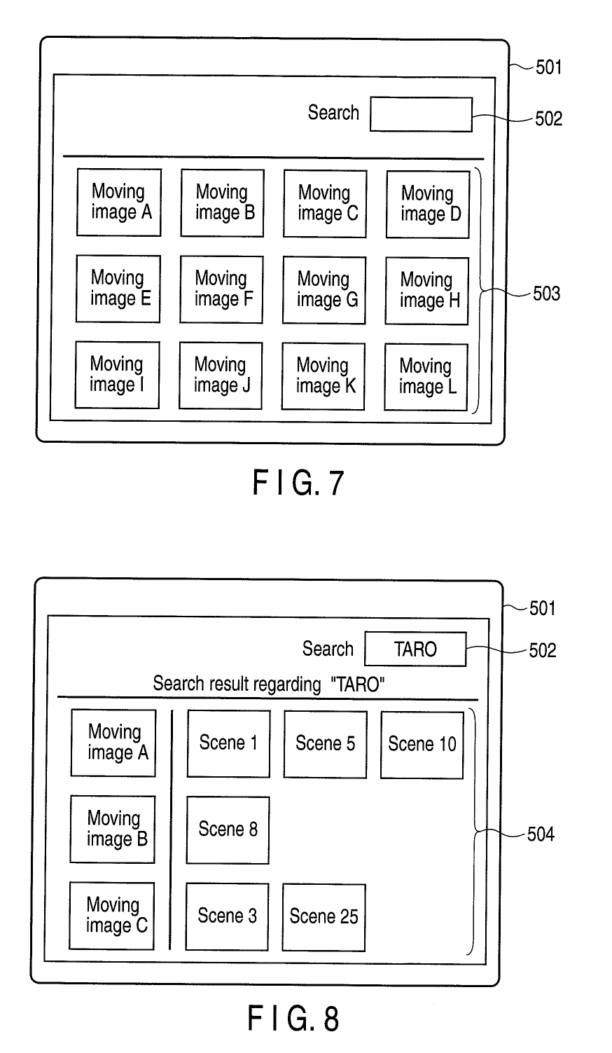

When search of the moving image data is requested by the user, the video processing program 202A displays a moving image search screen 501 as shown in FIG. 7 on the display screen. The moving image search screen 501 includes an input field 502 for inputting the human name as a search condition, and a moving image list display area 503 for displaying the list of the moving image data to be searched. In the moving image list display area 503, for example, the list of the moving image data corresponding to the search index information generated by the video processing program 202A, is displayed.

The user inputs the human name registered in the face database 111A by typing in the input field 502. For example, when the human name “TARO” is input in the input field 502, by using the moving image data search module 203, the video processing program 202A searches the moving image data associated with the search index information including the human name “TARO”, from the moving image data group to be searched (block S15).

In this block S15, the video processing program 202A searches the scene associated with the input human name “TARO”, from each moving image data to be searched, based on the input human name “TARO” and the search index information of each one of the plurality of moving image data to be searched. Then, based on the result of the search processing, the video processing program 202A displays on the moving image search screen 501, the list of the scenes associated with the human name “TARO” for each moving image data where the face image corresponding to the human name “TARO” appears. FIG. 8 shows the example of the search result screen. As shown in FIG. 8, the search result display area 504 corresponding to the human name “TARO” is displayed on the moving image search screen 501. The list of the scenes associated with the human name “TARO” is displayed on this search result display area 504, for each moving image data in which the face image corresponding to the human name “TARO” appears. For example, when the face image corresponding to the human name “TARO” appears in the scenes 1, 5, 10 of the moving image data A, and the face image corresponding to the human name “TARO” appears in the scene 8 of the moving image data B, and the face image corresponding to the human name “TARO” appears in the scenes 3, 25 of the moving image data C, the moving image data A, B, C are displayed on the search result display area 504, as the list of the moving image data including the face image corresponding to the human name “TARO”, and the list of the scenes, in which the face image corresponding to the human name “TARO” appears, is displayed on the search result display area 504, for each moving image data A, B, C.

The user can select an arbitrary scene to be played back from the list of the scenes displayed on the search result display area 504. For example, when the scene 5 of the moving image data A is selected to be played back by the user, the video processing program 202A starts playback of the moving image data A from the scene 5. Also, for example, when the scene 3 of the moving image data C is selected to be played back by the user, the video processing program 202A starts playback of the moving image data C from the scene 3. Accordingly, the user can selectively view only the scene in which user's desired person appears, out of a plurality of moving image data stored in the HDD 111.

Only by designating each scene desired to register in a playlist, from the list of the scenes displayed on the search result display area 504, the user can prepare the playlist regarding the human name “TARO”. Namely, when the user selects a scene group to be registered in the playlist from the list of the scenes displayed on the search result display area 504, by using the playlist preparation module 206, the video processing program 202A prepares the playlist including the identifier corresponding to each selected scene (for example, the file name of the moving image data including the selected scene, and the time information corresponding to the selected scene). Of course, it is also possible to prepare the playlist including the identifier corresponding to all scenes displayed on the search result display area 504 respectively (for example, the file name of each moving image data, and the time information corresponding to each scene), or the playlist including the identifier corresponding to all moving image data displayed on the search result display area 504 respectively.

As described above, according to this embodiment, the moving image data and the scene in which user's desired person appears can be instantaneously searched by only inputting the human name. Therefore, higher speed human search is possible than the search using a seek bar, etc. In addition, the playlist for each person can be easily prepared.

Note that all procedures of the video processing of this embodiment can be realized by software. Therefore, by introducing this software into a normal computer through a computer readable storage medium, the same effect as that of this embodiment can be realized.

In addition, the electronic apparatus of this embodiment can be realized not only by computer, but also by various consumer electronic apparatuses such as a recording/playback device (HDD recorder and DVD recorder) and a television device. In this case, the function of the video processing program 202A can be realized by hardware such as a DSP and a microcomputer.

In addition, the present invention is not limited to the aforementioned embodiments, and in an implementation stage, the constituent elements can be variously modified in a scope not departing from the gist of the present invention. Further, various inventions can be formed by suitable combination of a plurality of constituent elements disclosed in the aforementioned embodiments. For example, several constituent elements may be deleted from all constituent elements shown in the embodiments. Further, the constituent elements may be suitably combined with each other in a different embodiment.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a storage device configured to store a plurality of reference face images and a plurality of names corresponding to the reference face images;
a face image extraction module configured to extract a plurality of face images from video data;
a matching module configured to compare the face images extracted from the video data with the reference face images, and to identify reference face images that appear in the video;
an association module configured to associate a name corresponding to the identified reference face image, with the video as search index information, based on a result of the matching; and
a search module configured to search video data associated with a name entered by a user from a plurality of video data, based on the entered name and the search index information of the plurality of video data.

2. The electronic apparatus of claim 1, wherein the extraction module is configured to extract the plurality of face images respectively from a plurality of scenes comprised in the video data,
the matching module is configured to identify the reference face image comprised in the plurality of scenes, by comparing the face image extracted from the plurality of scenes with the plurality of reference face images,
the association module is configured to associate the scenes with the names corresponding to the reference face images in the scenes, and
the search module is configured to search a scene associated with a name entered by a user from the video data, based on the entered name and the search index information of the video data.

3. The electronic apparatus of claim 2, further comprising:
a display processor configured to display on a display screen a list of the scenes associated with the entered name, for video data associated with the entered name, based on a result of a search by the search module; and
a playback processor configured to play back video data comprising a scene selected by a user from the list of the scenes on the display screen.

4. The electronic apparatus of claim 1, further comprising:
a playlist preparation module configured to prepare playlist information comprising identifiers for identifying a plurality of the searched video data respectively, based on a result of a search by the search module; and
a playback module configured to sequentially play back the plurality of video data identified by the identifiers comprised in the playlist information, in response to an input of a playback request event.

5. An electronic apparatus comprising:
a storage device configured to store a plurality of reference face images and a plurality of names corresponding to the reference face images;
a face image extraction module configured to extract a plurality of face images from a plurality of scenes comprised in video data;
a matching module configured to comparing the face images extracted from the scenes with the reference face images, and to identify the reference face images that appear in the scenes;
a search index information generator configured to generate search index information indicative of names corresponding to the reference face images that appear in the scenes based on a result of the matching;
a search module configured to search a scene in which the face image corresponding to a name entered by a user appears based on the entered name and the search index information corresponding to the video data; and
a display processor configured to display on a display screen a list of scenes associated with the face image corresponding to the entered name, for video data associated with the entered names, based on a result of a search by the search module.

6. The electronic apparatus of claim 5, further comprising:
a playlist preparation module configured to prepare playlist information comprising an identifier for addressing a scene selected by a user from the list of the scenes on the display screen; and
a playback module configured to playback scene addressed by the identifier comprised in the playlist information, in response to an input of a playback request event.

7. A method of searching video data comprising an object, by using a database storing a plurality of reference face images and a plurality of names corresponding to the reference face images, comprising:
extracting a plurality of face images from video data;
matching that comprises:
comparing the plurality of face images extracted from the video data with the reference face images; and
identifying a reference face image comprised in the video data;
associating a name corresponding to the identified reference face image with the video data as search index information; and
searching video data associated with the entered name, from a plurality of video data, based on a name entered by a user and the search index information of the plurality of video data.

8. The method of claim 7, wherein the extracting the face image comprises extracting the plurality of face images respectively from a plurality of scenes in the video data,
the matching comprises identifying the reference face image comprised in the plurality of scenes, by comparing the face image extracted from the plurality of scenes with the plurality of reference face images,
the associating comprises associating the scenes with the names corresponding to the reference face images in the scenes, and
the searching comprises searching a scene associated with a name entered by a user from the video data based on the entered name and the search index information of the video data.

9. The method of claim 8, further comprising:
displaying a list of the scenes associated with the entered names on a display screen based on a result of the search; and
playing back from video data comprising a scene selected by a user from the list of the scenes on the display screen.

10. The method of claim 7, further comprising:
preparing playlist information comprising identifiers for identifying a plurality of the searched video data respectively, based on a result of the search; and
playing back the plurality of video data identified by the identifiers comprised in the playlist information, in response to an input of a playback event.
